(19) United States
(12) Patent Application Publication
(10) Pub. No.: US 2023/0042811 A1
(43) Pub. Date: Feb. 9, 2023

(54) CYCLONE UNIT FOR A WET VACUUM CLEANER

(71) Applicant: KONINKLIJKE PHILIPS N.V., Eindhoven (NL)

(72) Inventors: Albert AL-SHORACHI, Eindhoven (NL); Aaldert Geert ZIJLSTRA, Eindhoven (NL); Johannes Tseard VAN DER KOOI, Eindhoven (NL)

(73) Assignee: KONINKLIJKE PHILIPS N.V., Eindhoven (NL)

(21) Appl. No.: 17/793,408

(22) PCT Filed: Jan. 11, 2021
(86) PCT No.: PCT/EP2021/050378

§ 371 Date: Jul. 17, 2022

(30) Foreign Application Priority Data
Jan. 17, 2020 (EP) 20152356.0

(51) Int. Cl. A47L 9/16; A47L 7/00; B04C 3/06; B04C 9/00

(52) U.S. Cl. CPC A47L 9/165; A47L 7/0019; A47L 9/1608; A47L 9/1658; B04C 3/06; B04C 9/00; B04C 2009/005

(57) ABSTRACT

A cyclone unit is for separating liquid and particles from a suction flow. A main flow inlet to the outer housing of the cyclone unit includes an opening. The transition between the main flow inlet and the outer housing at this opening has, at least for a portion of the opening, a radius of curvature of at least 0.5 mm. The large radius of curvature prevents the formation of static water drops.

### FIELD OF THE INVENTION

This invention relates to cyclone units, for example for use in wet vacuum cleaners.

### BACKGROUND OF THE INVENTION

Traditionally, hard floor cleaning has involved first vacuuming the floor, followed by mopping it. Vacuuming removes the fine dust and coarse dirt, while mopping removes any very fine dust and stains.

There are now many available appliances on the market that claim to vacuum and mop in one go, and this is what is referred to by a “wet vacuum cleaner”. Many of these appliances have a vacuum nozzle for picking up the coarse dirt by means of an airflow and a (wet) cloth or brush for removing the stains. These wet cloths or brushes can be pre-wetted or can be wetted by the consumer but also in some cases they can be wetted by the appliance (by means of a liquid but also by means of steam).

The wet vacuum cleaner then needs to be able to collect moist dirt from the floor and transport it to the dirt container. This is achieved using the airflow generated by a motor and fan arrangement. The moist dirt and liquid in the form of droplets needs to be separated from the airflow. The moist dirt and liquid enters the dirt container whereas the remaining airflow passes through the fan and any post-filtering units, and exits the appliance.

It is known to use labyrinths and filters or cyclone units to separate liquid and moist dirt from the air flow. This invention relates in particular to the use of a cyclone.

In cyclonic systems, centrifugal forces arise by rotating air inside a chamber. The air flows in a helical pattern, for example beginning at the top of the cyclone chamber and ending at the bottom, before exiting the cyclone through the center of the cyclone and out of the top. Particles and liquid droplets dragged along in the rotating stream have too much inertia to follow the tight curve of the air flow path, and will strike the outside wall, then move along the wall to the bottom of the cyclone chamber (or enter a separate dirty water chamber) where they can be removed.

Cyclones are widely used as a way to separate dry particles from air. However, the use of a cyclone for separating water droplets (and dirt particles) from air is more difficult, because the water tends to creep to the exit along with the main air flow. The main challenge for the use of a cyclone with a wet flow is thus to guide the water along the walls of the cyclone unit towards a collector while preventing water becoming airborne again.

One issue for cyclonic devices is that in addition to the primary helical flow, there are secondary airflow patterns which arise, leading for example to the transport of water drops towards and along the top of the cyclone chamber. When water reaches the top, it can flow to the outlet of the cyclone unit (the output for example extends into the chamber from the top), giving an ineffective separation.

Another issue is the size of water droplets. A cyclone unit for example has an inlet conduit that couples to an opening in the cyclone housing, in particular with a tangential component of the direction of the inlet conduit. It has been found that the connection between the inlet conduit and the opening in the cyclone housing can promote formation of large static water droplets. When these are eventually dislodged they can become airborne as a finer mist, which is then carried to the main air flow outlet, again giving a reduction in efficiency of the water separation.

EP 2 581 018, US 2019/307301, U.S. Pat. No. 3,877,902 and WO 2011/132323 disclose wet and dry cyclonic vacuum cleaners.

There is therefore a need for an improved cyclone unit design suitable for use in a wet vacuum cleaner.

### SUMMARY OF THE INVENTION

The invention is defined by the claims.

According to examples in accordance with an aspect of the invention, there is provided a cyclone unit for separating liquid and particles from a flow through the cyclone unit, the cyclone unit having a cyclone axis of rotation, wherein the cyclone unit comprises:

an outer housing having an outer side wall, a first end and a second end positioned along the cyclone axis;

a main flow inlet to the outer housing comprising an opening in the outer housing;

a main flow outlet from the outer housing closer to the first end than the main flow inlet,

wherein the transition between the main flow inlet and the outer housing has, at least for a portion of the opening on the first end side of the main flow inlet, a radius of curvature of at least 0.5 mm.

The curvature is in a plane perpendicular to the local tangent to the main flow inlet.

This cyclone unit is used to separate water (and debris) from a flow, for example generated by the suction of the motor and fan. The cyclone is generated around a cyclone axis and travels in the direction from the second end (e.g. a top) towards a spaced apart opposite first end (e.g. a bottom). Note that the terms “top” and “bottom” used in this application are not intended to refer to gravitational orientations. The top of the outer housing may be considered to be the end nearest which the main flow entry is provided, and the bottom of the outer housing may be considered to be the end nearest the debris collection outlet or chamber.

The first end may for example be a debris collection end and the second end may be an end through which an outlet conduit passes. A debris collection outlet from the outer housing may be provided, or else there may be a collection area or chamber within the outer housing. The main flow outlet (i.e. the entrance to the outlet conduit) is for example positioned at a greater spacing from the second end than the main flow inlet. Thus, the flow within the cyclone unit is generally away from the second end towards the collection outlet.

The dirt inlet is for example for attachment to a vacuum cleaner head or other vacuum cleaner accessory.

The transition between between the main flow inlet and the outer housing is the surface encountered when following a path from main flow inlet to the outer housing. Thus, it is the curvature encountered by the flow which has advanced along the direction of the main flow inlet. The curvature is in a plane perpendicular to the local tangent to the main flow inlet.

The large radius of curvature avoids sharp intersection edges at the locations where water drops may form. If locations are present where large water drops cannot flow, it has been found that they will eventually be broken into small droplets once dislodged, and then flow to the main flow outlet. The use of large curvature surfaces prevents this.

The part of the opening facing the first end (e.g. the bottom) is the area where most liquid enters the separation system. Thus, it is desirable to prevent large water droplets collecting in this region.

The radius of curvature may be at least 1 mm, for example at least 2 mm, for example at least 3 mm.

The cyclone unit preferably comprises a main flow inlet conduit which connects to the main flow inlet, wherein the main flow inlet conduit has a first cross sectional area, and the area of the opening is a larger, second, cross sectional area.

In this way, there is a flow area increase at the transition from the flow inlet conduit to the cyclone unit. This reduces the flow speed. This measure may be designed to prevent water droplets of a size suitable for collection being broken up into smaller droplets, which can more easily flow to the outlet.

The second cross sectional area is for example at least 1.1 times the first cross sectional area. It may be at least 1.2 times, for example at least 1.3 times, for example at least 1.4 times the first cross sectional area.

The main flow inlet to the outer housing opening may have an effective hydraulic inlet diameter, and the main flow inlet is spaced internally from the second end by a separation distance of at least 0.1 times the effective hydraulic inlet diameter.

The main flow inlet to the cyclone unit is thus spaced apart from the second end. This means that a secondary flow towards the second end (e.g. towards the top, and in addition to the helical flow towards the bottom) is less able to cause liquid to attach to the inner face of the second end, from where it can run down to the main flow outlet and be drawn out with the main air flow. Thus, this design reduces the amount of water that is entrained in the main outlet flow. The spacing is preferably a step or transition at or near the location of the main flow inlet.

The opening of the main flow inlet does not need to be circular. The “effective hydraulic inlet diameter” may be taken to be the diameter for a circle with the same area as the opening. The area of the opening may be considered to be the area of the missing portion of the outer wall which forms the inlet. This area may be the area of a curved (missing) wall portion, or it may be approximated as the best fit planar surface to the outer contour of the opening.

The main flow inlet is for example spaced internally from the second end by a spacing between 0.1 and 2 times, more preferably between 0.5 and 1.5 times, and most preferably between 0.9 and 1.1 times the effective hydraulic inlet diameter.

The main flow inlet is for example spaced internally from the second end by a separation distance between 5 mm and 50 mm. The spacing needed is preferably small so the total appliance is small and therefore easy to store and handle.

A main flow inlet conduit is for example provided which connects to the opening in the outer housing. It typically defines a flow direction which is partly radially inwardly directed and partly circumferentially (i.e. tangentially) directed around the outer housing, to give a compact overall design. The airflow is for example mostly tangential and partly radial.

The main flow inlet conduit for example extends perpendicularly to the cyclone axis (at its end where it connects to the main flow inlet) with a tangential component and a radially inward component. In this case, the main flow inlet conduit is parallel with, but spaced from, the second end.

Instead, the main flow inlet conduit may extend in a direction offset from the perpendicular to the cyclone axis and facing towards the second end.

This means that the primary input flow is inclined towards the second end (e.g. towards the top). This reduces the pressure difference between the inside and outside of the cyclonic flow near the second end, so that any droplets which have collected on the inner face of the second end (e.g. the top) are still subjected to a drag force and thus do not collect and flow towards the main flow outlet. A tangential component of the primary input flow is maintained.

The main flow inlet conduit may extend in a direction offset by 0 to 90 degrees, more preferably 0 to 30 degrees, more preferably 10 to 25 degrees from the perpendicular to the cyclone axis.

An outlet conduit is for example provided which in one example extends from the second end into a central region of the outer housing, and the main flow outlet is at the end of the outlet conduit.

This outlet conduit for example defines a vortex finder within the outer housing, and the main flow outlet (at the end of the outlet conduit) is located at a position centrally within the interior volume of the outer housing. This is a typical configuration for a cyclone unit.

The flow outlet may extend parallel to the cyclone axis. At least a portion of the outer housing is for example cylindrical, around the cyclone axis.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a wet vacuum cleaner;

FIG. 2 shows in schematic form the general known configuration of the cyclone unit;

FIG. 3 is used to show a first issue which arises in the known design;

FIG. 4 is used to show a second issue which arises in the known design;

FIG. 5 shows first and second design features which may be used in a design in accordance with examples of the invention;

FIG. 6 shows a cross section of a cyclone unit design with the design features of FIG. 5 as well as a third design feature;

FIG. 7 shows a view along the cyclone axis of the junction between the outer side wall and the main flow inlet conduit;

FIG. 8 shows a conventional transition between the main flow inlet conduit and the outer side wall;

FIG. 9 shows a modification to the transition to use a fourth design feature;

FIG. 10 shows a view from within the cyclone chamber looking through the main flow inlet into the main flow inlet conduit;

FIG. 11 shows an external side view of the same design as FIG. 10;

FIG. 12 shows a view from above the cyclone unit, with a top section removed, to show the transition between the main flow inlet conduit and the outer side wall;

FIG. 13 shows some alternative representative shapes for the surface which closes the cyclone unit at the inlet end; and

FIG. 14 is used to explain how curvatures may be defined.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a cyclone unit for separating liquid and particles from a suction flow. A main flow inlet to the outer housing of the cyclone unit comprises an opening. The transition between the main flow inlet and the outer housing at this opening has, at least for a portion of the opening, a radius of curvature of at least 0.5 mm. The large radius of curvature prevents the formation of static water drops.

The invention relates specifically to the design of a cyclone unit suitable for a wet vacuum cleaner, although it may be used in any application requiring separation of liquid from a flow. Before describing the cyclone unit in detail, an example will be given of the general configuration of a wet vacuum cleaner.

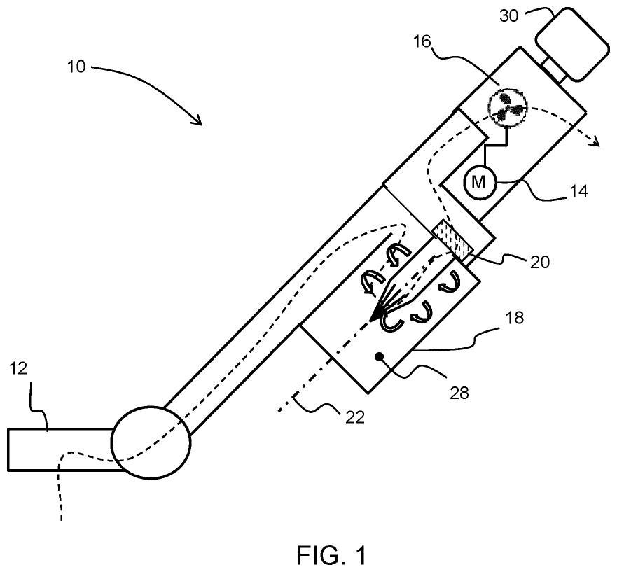

FIG. 1 shows a wet vacuum cleaner 10, comprising a vacuum cleaner head 12, and a motor 14 and a fan 16 for delivering suction to the vacuum cleaner head.

A cyclone unit 18 is provided for separating liquid and particles from a flow generated by the suction of the motor and fan.

The motor for example comprises a bypass motor. This type of motor can tolerate water content in the air flow, because the drawn in air flow is not used for motor cooling and is isolated from the motor parts. Instead, ambient air is drawn in to the motor for cooling purposes.

The cyclone unit 18 is part of a wet dirt management system, which dirt may included additional filters. The dirt management system has a collection chamber for collecting the separated moisture and dirt. This may be an internal part of the cyclone unit or there may be a separate a waste water collection reservoir to which the cyclone unit connects. An outlet filter 20 may for example be provided between the outlet flow of the cyclone and the motor and fan as shown.

The cyclone unit has a cyclone axis of rotation 22. This axis may be aligned parallel with the general length axis of the vacuum cleaner (as in the case in FIG. 1), but this is not essential. The axis of rotation 22 may instead be perpendicular to the general length axis or oriented in other ways. The cyclone unit has an inlet opening, and the flow direction through the inlet opening is perpendicular to the cyclone axis 22, with a predominantly tangential and partly radially inward direction, to promote the desired helical flow condition within the cyclone unit.

A collection volume 28 is for example below the cyclone chamber (when the vacuum cleaner is upright) so that water is collected under gravity.

There is a handle 30 at the opposite end to the head 12.

The vacuum cleaner shown is a stick vacuum cleaner so that in use the head 12 forms the only contact with the surface to be vacuumed. Of course, it may be an upright vacuum cleaner or a canister vacuum cleaner. The invention relates to design features of the cyclone unit, and may be applied to any wet vacuum cleaner.

The user may be required to deliver water to the surface being vacuumed independently of the vacuum cleaner. However, the wet dirt management system may instead also include a clean water reservoir for delivering water to the vacuum nozzle.

The vacuum cleaner head for example has a rotary brush to which water is delivered from the clean water reservoir, and hence also has an inlet for receiving water from the clean water reservoir. The vacuum cleaner head is specifically designed to pick up wet dirt and optionally also perform the floor wetting.

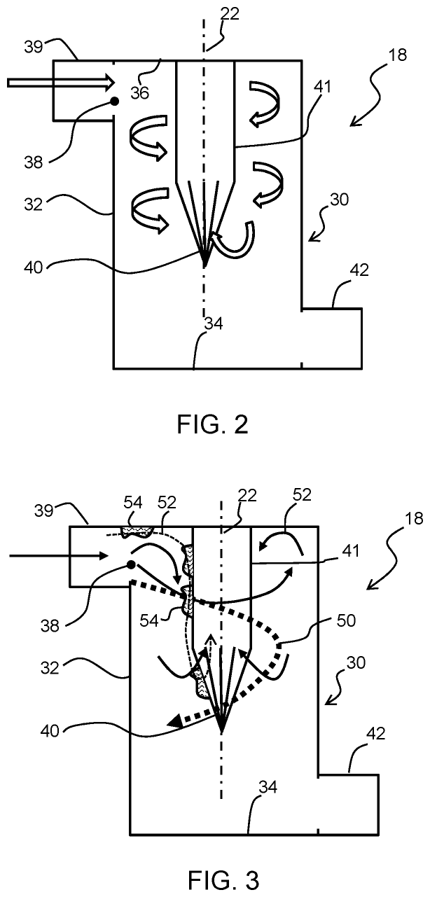

FIG. 2 shows in schematic form the general known configuration of a cyclone unit 18.

The cyclone unit comprises an outer housing 30 having an outer side wall 32, a first end 34 and a second end 36 spaced apart along the cyclone axis 22. The second end 36 forms a surface (which will thus also be referred to as reference 36) which closes the internal volume of the cyclone unit at that end.

The surface 36 is shown in FIG. 2 (and in the other figures) to be a flat surface. However, this is not necessary. The surface 36 may have a more complex three dimensional shape.

The first end 34 may be considered to be the bottom and the second end 36 may be considered to be the top, without implying any particular orientation of the cyclone unit.

A main flow inlet 38 is provided to the outer side wall 32 of the housing 30, comprising an opening in the outer housing. The opening has an effective hydraulic inlet diameter as discussed above, namely the diameter for a circle with the same area as the opening.

The opening may be considered to be a missing portion of the outer side wall 32. This missing portion has an area. This area may thus be considered to be the area of the missing portion of the outer side wall. If the outer side wall is cylindrical, the missing portion will be a portion of a cylindrical surface. However, the area may instead be determined as a smaller planar area which is a closest approximation to the shape of the inlet.

A main flow inlet conduit 39 connects to the opening in the outer housing. The main flow inlet 38 and the main flow inlet conduit 39 are only shown schematically in FIG. 2. In particular, the main flow inlet conduit 39 is shown as radially directed, whereas in practice the main flow inlet has a predominantly tangential direction as well as a radial direction, as will be seen more clearly below. The direction of flow created by the main flow inlet conduit 39 is designed to create the desired helical flow conditions within the cyclone unit.

A main flow outlet 40 is provided from the outer housing 30 closer to the first end 34 than the main flow inlet 38. Thus, the main flow outlet is nearer the bottom. An outlet conduit 41 extends from the second end 36 into a central region of the outer housing. The main flow outlet 40 is at the end of the outlet conduit 41. This outlet conduit 41 and the main flow outlet 40 for example define a vortex finder.

A collection outlet 42 is provided from the outer housing 30 for the collection of moisture and debris. However the outer housing may itself instead define a collection chamber.

Dirt and water should not be able to come back to the cyclone as soon as they have passed the collection outlet 42. The vortex finder has a shape to guarantee a stable vortex/cyclone. The position of the vortex finder relative to the main flow inlet in part determines the separation performance.

FIG. 3 is used to show a first issue which arises in this design.

There is a primary rotational flow 50 from the main flow inlet 38 to the main flow outlet 40, but there is also a secondary air flow pattern 52, which is able to transport liquid towards and along the second end 36 (the top). This is shown as droplets 54. When water upwardly reaches the second end 36, it can flow down the outlet conduit 41 and eventually be sucked out from the main flow outlet 40, reducing the effectiveness of the liquid separation.

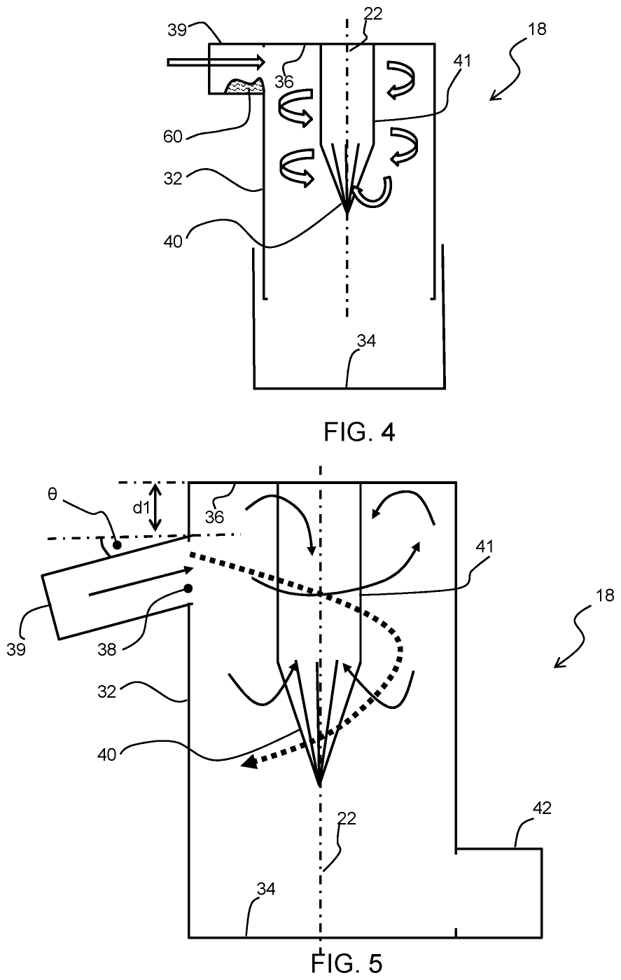

FIG. 4 is used to show a second issue which arises in this design.

Where the main flow inlet conduit 39 couples to the opening in the outer wall of the housing, the formation of large static water droplets may arise, as represented by droplet 60. When these are eventually dislodged they can become airborne as a finer mist, which is then carried to the main air flow outlet, again giving a reduction in efficiency of the water separation.

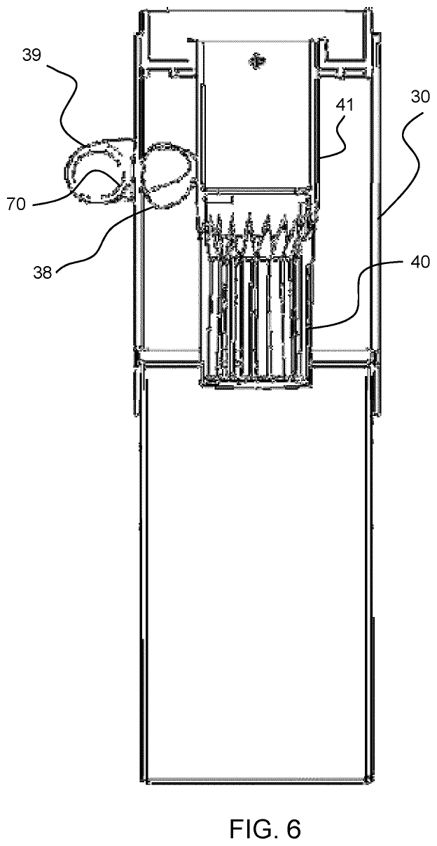

FIG. 5 shows first and second design features relating to these issues

In accordance with a first design feature, the main flow inlet 38 is spaced internally below the second end of the outer housing 30, by a separation distance dl. This separation distance is greater than 0.1 times the effective hydraulic inlet diameter defined above.

The separation distance may be more than 0.3 times, for example more than 0.5 times, for example more than 0.9 times the effective hydraulic inlet diameter. It is preferably also below 2 times the effective hydraulic inlet diameter, to avoid a significant increase in the axial length of the cyclone unit.

The spacing may thus be between 0.1 and 2 times, more preferably between 0.5 and 1.5 times, and most preferably between 0.9 and 1.1 times the effective hydraulic inlet diameter.

The example of FIG. 5 shows a cyclone unit with a cylindrical side wall and a planar top wall, hence a planar surface 36. In such a case, the spacing dl is simple to define. However, for a non planar surface 36 the spacing is less easily defined. The aim of the spacing is to prevent a secondary flow towards the surface 36 (e.g. towards the top), in addition to the helical flow towards the outlet, causing liquid to attach to the inner face of the surface.

The spacing is thus preferably near the main flow inlet 38, i.e. at a radially outward part of the surface 36, where the surface 36 connects to the outer side wall.

The design is such that there is at least a part of the surface 36 which is positioned along the axis 22 spaced by a distance of dl or more than dl from the top of the main flow inlet 38.

The separation distance is thus between the top of the main flow inlet and a portion of the surface 36, i.e. the underside face of the second end. Thus, the spacing may be considered as the axial distance between the nearest (top) part of the inlet and the highest part of the cyclone chamber (if it has a non-planar second end).

For a non-planar second end, the spacing dl is preferably present within the outer 50%, or within the outer 40% or within the outer 30% or within the outer 20% of the radius of the surface 36 from the axis 22. Thus, the step is provided at or near the outer side wall, and hence at or near the main flow inlet 38.

By displacing the main flow inlet from the second end in this way, the secondary flow discussed above towards the second end (i.e. towards the top) is less able to cause liquid to attach to the inner surface of the second end. Thus, this design reduces the amount of water that is entrained in the main outlet flow.

The main flow inlet 38 is for example spaced internally below the second end 36 by a separation distance between 5 mm and 50 mm. The spacing needed is relatively small so does not require significant additional space.

The main flow inlet conduit 39 may extend perpendicularly to the cyclone axis, i.e. horizontally for a vertical cyclone chamber.

However, FIG. 5 shows a second design feature by which the main flow inlet conduit 39 extends in a direction offset from the perpendicular to the cyclone axis and facing towards the second end. The offset is by an angle θ as shown.

By moving the main flow inlet downwards, an easier path for the secondary flow is created. By directing the main inlet flow conduit slightly upwardly, the secondary flow is counteracted by reducing the pressure difference between the inside and the outside of the cyclone at the location of the second end. This in turn prevents any droplets that may have ended up at the second end to experience less or inward drag force.

Thus, the primary input flow is made to be inclined towards the second end (i.e. towards the top, second end).

The flow inlet conduit may extend in a direction offset by an angle θ in the range 0 to 90 degrees, more preferably 0 to 30 degrees, more preferably 10 to 25 degrees from the perpendicular to the cyclone axis. An optimum is found in the range 15 to 20 degrees.

FIG. 6 shows a cross section of a cyclone unit with these design features.

In addition, FIG. 6 shows a third design feature.

The main flow inlet conduit 39 can be seen with a circular cross section 70 with a first cross sectional area. The hydraulic area of the opening 38, as defined above, is a larger, second, cross sectional area.

In this way, there is a flow area increase at the transition from the flow inlet conduit 39 to the cyclone unit. This reduces the flow speed. This measure may be designed to prevent water droplets of a size suitable for collection being broken up into smaller droplets, which can more easily flow to the outlet.

The main flow inlet conduit has a constant cross sectional area until it reaches the first intersection with the outer housing. From that point, the cross sectional area expands to reduce the air inlet speed. The separation process needs a certain flow speed, but when the speed is too high, larger water droplets will be broken down into droplets that are more able to travel with the airstream. The area expansion just at the entrance into the cyclone chamber prevents this issue.

The second cross sectional area is for example at least 1.1 times the first cross sectional area. It may be at least 1.2 times, for example at least 1.3 times, for example at least 1.4 times the first cross sectional area.

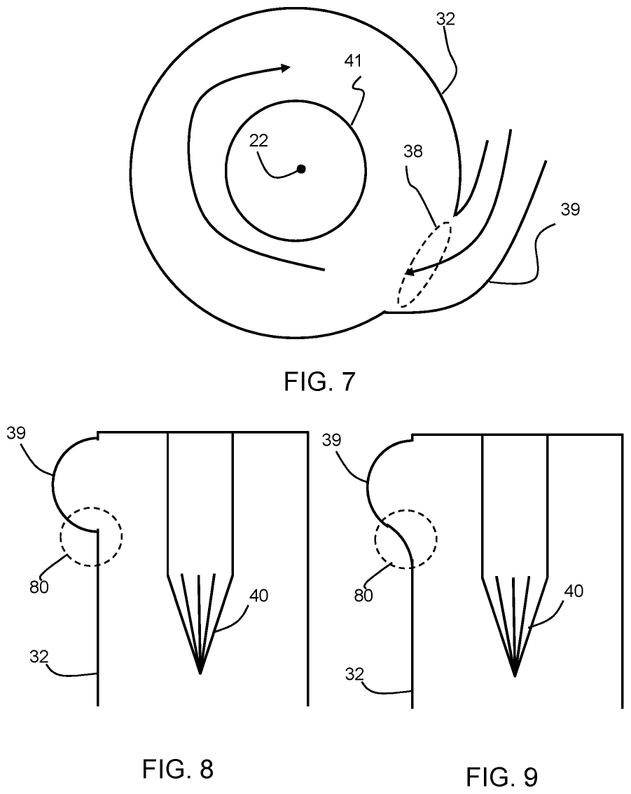

FIG. 7 shows a view along the cyclone axis 22 of the junction between the outer side wall 32 and the main flow inlet conduit. It shows that the main flow inlet conduits approaches the opening 38 tangentially.

A fourth design feature relates to the interface between the outer side wall 32 and the main flow inlet conduit 39. The fourth design feature is that inlet should gradually evolve into the housing. A gradual shape ensures that liquid enters the cyclone volume in a controlled manner. A sharp edge at the inlet tends to result in accumulation of larger drops breaking down into smaller drops, which eventually lead to water on the outlet conduit 41 (i.e. the vortex finder).

FIG. 8 shows a conventional transition between the main flow inlet conduit 39 and the outer side wall 32. The abrupt edges in region 80 have been found to cause the collection of large droplets.

FIG. 9 shows the modification to the transition between the main flow inlet conduit 39 and the outer side wall 32 in accordance with this fourth feature. In region 80, the part of the inlet facing the first end (i.e. the bottom area) is the area where most liquid enters the separation system. A minimum radius of curvature is set in this area. The radius of curvature may be at least 0.5 mm, for example at least 1 mm, for example at least 2 mm, for example at least 3 mm.

In general, larger edge radii are preferable. The radius may be at least as large as the capillary length (aka capillary constant) which (for pure water) is around 3 mm. Thus, for a vacuum cleaner application, the liquid can be assumed to be water (with some contaminants and possibly cleaning aid) and hence the radius of curvature can be defined in absolute terms. However, the physical effect under consideration is the formation and dispersal of droplets, and this depends not only on the surface shape but also on the liquid characteristics. The capillary length is a length scaling factor that relates gravity and surface tension, and it governs the behavior of menisci, based on the equilibrium between surface forces and gravity.

In particular, the capillary length is the typical size scale of droplets below which surface tension will tend to keep the droplets from breaking up by external forces. If the wall on which the liquid is flowing has a radius of curvature which is larger than this typical droplet size scale, the droplet movement will not be significantly hampered. If the radius of curvature is smaller however, the liquid needs to deform considerably causing it to be slowed or even pinned depending on the advancing contact angle.

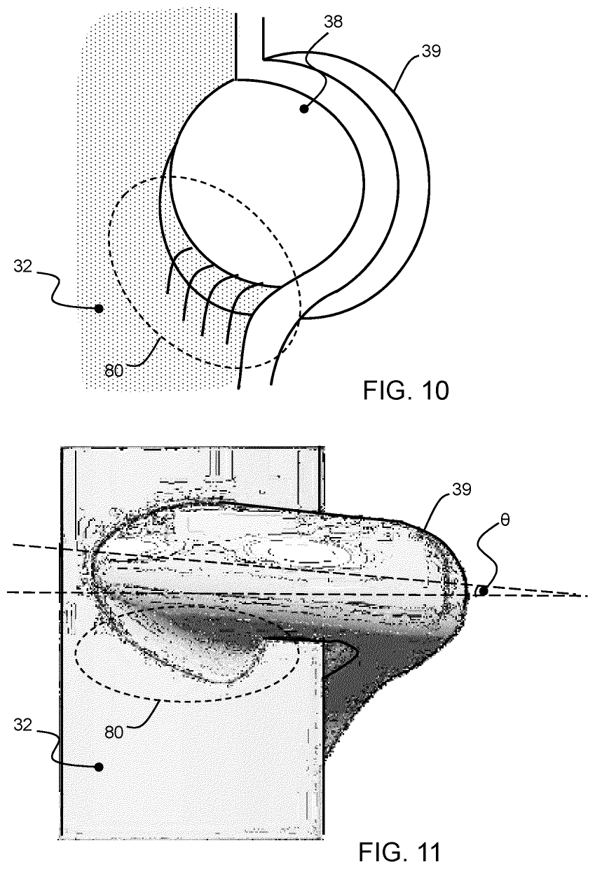

FIG. 10 shows a view from within the cyclone chamber looking through the main flow inlet 38 into the main flow inlet conduit. 39. The curvature in region 80 is represented.

FIG. 11 shows an external side view of the same design as FIG. 10. It shows the inclination angle θ.

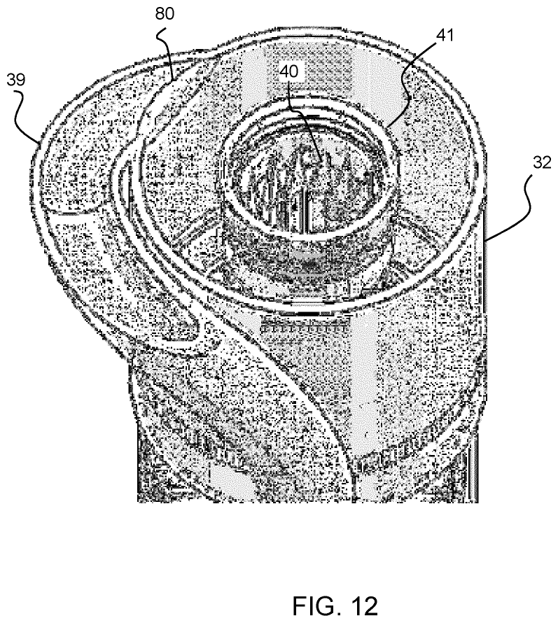

FIG. 12 shows a view from above the cyclone unit, with a top section removed, to show the transition between the main flow inlet conduit 39 and the outer side wall 32.

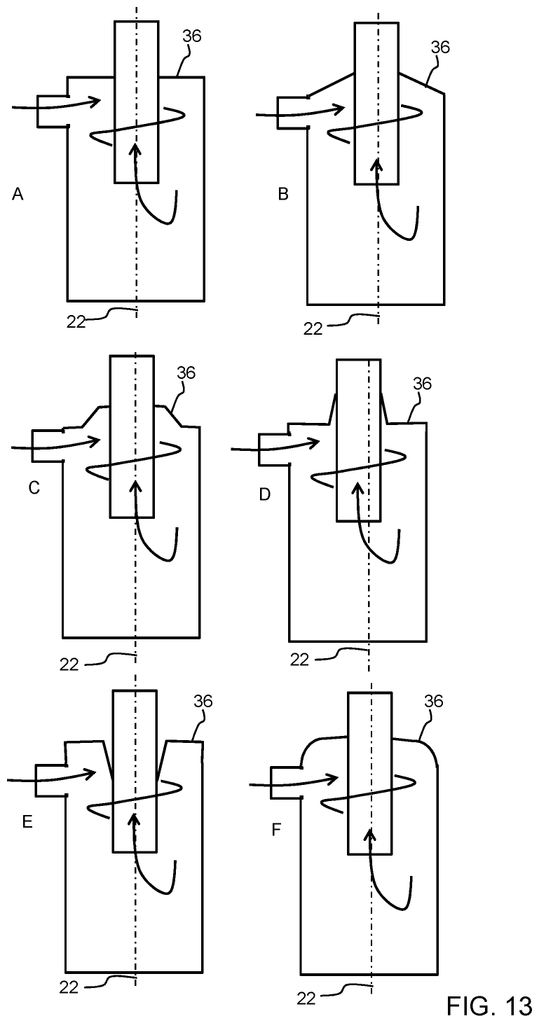

As mentioned above, the ends of the cyclone unit do not need to be planar. FIG. 13 shows some alternative representative shapes for the surface 36 which closes the cyclone unit at the inlet end (termed the second end in the description above). In each case, at least a portion of the surface is spaced from the inlet opening by at least the spacing discussed above.

FIG. 13A shows a planar surface as in the examples above.

FIG. 13B shows a sloped conical surface. The radially innermost part of the conical surface has a spacing greater than the defined minimum spacing. Thus, there is a portion of the surface which has the required spacing. The minimum spacing may be reached before the radially innermost part, for example it may be reach even at the radially outermost 10%, or 20% or 30% of the surface (as discussed above).

FIG. 13B represents a possible limit for the slope of the surface 36, in that the desired effect may be lost if the slope in any less (i.e. if the second end is any flatter). The minimum slope angle is for example 15 degrees, for example 20 degrees, for example 30 degrees.

FIG. 13C shows a stepped surface with an initial step to a radially outermost flat portion and then a radially innermost sloped portion. There is again a portion of the surface which has the required spacing. This required spacing may arise at the initial step (near the main flow inlet) or it may arise at a position along the sloped portion.

FIG. 13D shows a surface with an initial step and a raised part near the outlet. The raised part may perform no function in the flow control and thus may be ignored. In any case, there is again a portion of the surface which has the required spacing and that portion is at the radial outer portion of the surface.

FIG. 13E shows a surface with an initial step and a sunken part near the outlet. The sunken part may perform no function in the flow control and thus may be ignored. In any case, there is again a portion of the surface which has the required spacing, and that portion is at the radial outer portion of the surface.

FIG. 13F shows a curved surface. It is sufficiently steep that the desired spacing arises sufficient outwardly from the axis 22.

Thus, there are many possible shapes of the surface that may perform the functions described above in controlling the overall flow characteristics.

As explained above, the invention relates in part to the curvature of the transition between the main flow inlet and the outer housing.

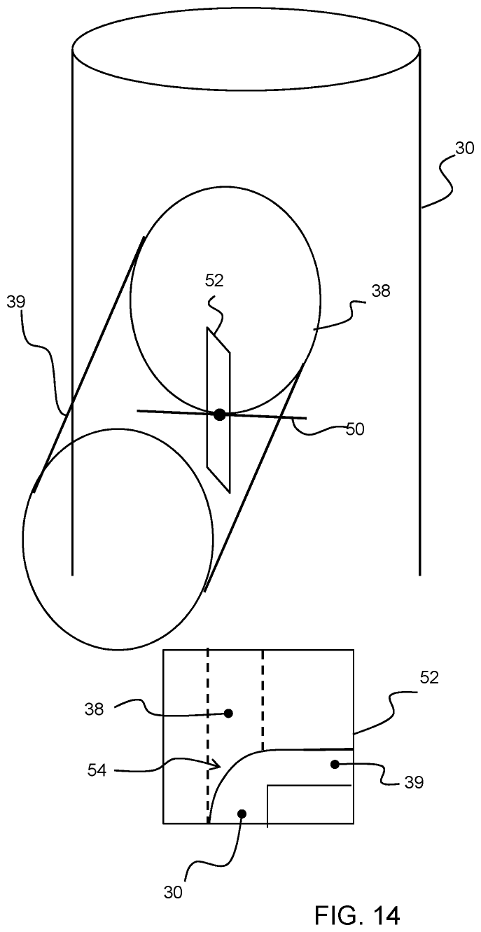

FIG. 14 is used to explain what is meant. The main flow inlet 38 has a certain (3D) shape, such as the shape of a circle cut into a cylinder of the outer housing 30, as shown. At any point around that shape, there is a local tangent 50. The local tangent is locally, i.e. when the portion of the shape can be approximated to be two dimensional, in the two dimensional plane. One such tangent 50 is shown at the bottom of the main flow inlet. The curvature is in a plane 52 perpendicular to that local tangent. This perpendicular plane 52 for example includes the general flow vector representing the main flow direction.

The curvature 54 is shown in the bottom of FIG. 14 at the transition between the main flow inlet 38 (i.e. the end of the flow inlet conduit 39) and the outer housing 30.

The main application for the cyclone unit is for a wet, or wet and dry, vacuum cleaner. However, the invention may be applied generally to any cyclone unit for separating liquid from a flow.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. A cyclone unit for separating liquid and particles from a flow through the cyclone unit, the cyclone unit having a cyclone axis of rotation, wherein the cyclone unit comprises:
an outer housing having an outer side wall, a first end and a second end positioned along the cyclone axis;
a main flow inlet to the outer housing comprising an opening in the outer housing;
a main flow outlet from the outer housing closer to the first end than the main flow inlet,
wherein the transition between the main flow inlet and the outer housing has, at least for a portion of the opening on the first end side of the main flow inlet, a radius of curvature of at least 0.5 mm in a plane perpendicular to the local tangent to the main flow inlet.

2. The cyclone unit as claimed in claim 1, wherein said radius of curvature is at least 1 mm, for example at least 2 mm, for example at least 3 mm.

3. The cyclone unit as claimed in claim 1, comprising a main flow inlet conduit which connects to the main flow inlet, wherein the main flow inlet conduit has a first cross sectional area, and the area of the opening is a larger, second, cross sectional area.

4. The cyclone unit as claimed in claim 3, wherein the second cross sectional area is at least 1.1 times the first cross sectional area.

5. The cyclone unit as claimed in claim 4, wherein the second cross sectional area is at least 1.2 times, for example at least 1.3 times, for example at least 1.4 times the first cross sectional area.

6. The cyclone unit as claimed in claim 1, wherein the main flow inlet to the outer housing opening has an effective hydraulic inlet diameter, and wherein the main flow inlet is spaced internally from the second end by a separation distance of at least 0.1 times the effective hydraulic inlet diameter.

7. The cyclone unit as claimed in claim 6, wherein the main flow inlet is spaced internally from the second end by a spacing between 0.1 and 2 times, more preferably between 0.5 and 1.5 times, and most preferably between 0.9, and 1.1 times the effective hydraulic inlet diameter.

8. The cyclone unit as claimed in claim 6, wherein the main flow inlet is spaced internally below the second end by a separation distance between 5 mm and 50 mm.

9. The cyclone unit as claimed in claim 1, comprising a main flow inlet conduit which connects to the main flow inlet, and which extends perpendicularly to the cyclone axis with a tangential component and a radially inward component.

10. The cyclone unit as claimed in claim 1, comprising a main flow inlet conduit which connects to the main flow inlet, and which extends in a direction offset from the perpendicular to the cyclone axis and facing towards the second end.

11. The cyclone unit as claimed in claim 10, wherein the main flow inlet conduit extends in a direction offset by 0 to 90 degrees, more preferably 0 to 30 degrees, and most preferably 10 to 25 degrees from the perpendicular to the cyclone axis.

12. The cyclone unit as claimed in claim 1, comprising an outlet conduit which substantially extends from the second end (36) into a central region of the outer housing, and the main flow outlet is at the end of the outlet conduit.

13. The cyclone unit as claimed in claim 1, wherein the main flow outlet extends parallel to the cyclone axis.

14. The cyclone unit as claimed in claim 1, wherein at least a portion of the outer housing is cylindrical around the cyclone axis.

15. A wet vacuum cleaner, comprising:
a dirt inlet;
a motor and fan for delivering suction to the dirt inlet; and
the cyclone unit of claim 1.
